(19) United States
(12) Patent Application Publication
(10) Pub. No.: US 2023/0030103 A1
(43) Pub. Date: Feb. 2, 2023

(54) ELECTRONIC APPARATUS

(71) Applicant: CANON KABUSHIKI KAISHA, Tokyo (JP)

(72) Inventor: Hideaki Yamamoto, Kanagawa (JP)

(21) Appl. No.: 17/963,272

(22) Filed: Oct. 11, 2022

Related U.S. Application Data
(63) Continuation of application No. PCT/JP2021/000487, filed on Jan. 8, 2021.

(30) Foreign Application Priority Data
Apr. 14, 2020 (JP) 2020-072109

(51) Int. Cl. H04N 5/232; G06F 3/01

(52) U.S. Cl. CPC H04N 5/23293; H04N 5/23216; G06F 3/013

(57) ABSTRACT

An electronic apparatus according to the present invention is an electronic apparatus that is capable of executing eye proximity sensing to sense whether an eye is in proximity of an eyepiece, and line-of-sight detection to detect a line-of-sight of a user, including: a first light source configured to emit light for the eye proximity sensing; a second light source configured to emit light for the line-of-sight detection; an eye proximity sensing sensor configured to receive light for the eye proximity sensing; and a line-of-sight detecting sensor configured to receive light for the line-of-sight detection, wherein a first wavelength, which is a peak wavelength of the light emitted by the first light source, is different from a second wavelength, which is a peak wavelength of the light emitted by the second light source.

### CROSS-REFERENCE TO RELATED APPLICATIONS

This application is a Continuation of International Patent Application No. PCT/JP2021/000487, filed Jan. 8, 2021, which claims the benefit of Japanese Patent Application No. 2020-072109, filed Apr. 14, 2020, which is hereby incorporated by reference herein in its entirety.

### BACKGROUND OF THE INVENTION

### Field of the Invention

The present invention relates to an electronic apparatus having a line-of-sight detecting function.

### Background Art

Cameras (including video cameras), which detect a line-of-sight (line-of-sight direction) of a user using a line-of-sight detecting function and performs distance measurement point selection and the like based on the result of the line-of-sight detection, have been commercialized. Cameras having an eye proximity sensing function that enables the line-of-sight detecting function only when the user's eye is in proximity of a finder (eyepiece) have also been commercialized.

PTL 1 discloses a technique to implement the line-of-sight detecting function and the eye proximity sensing function by installing a light-emitting diode and an eye proximity sensing sensor fused for the eye proximity sensing, separately from a light-emitting diode and a line-of-sight detecting sensor used for the line-of-sight detection. PTL 2 discloses a technique to uniquely specify each of a plurality of bright spots in the eye of the user. PTL 2 also discloses a technique to uniquely specify each of the plurality of bright spots by making the shapes of the plurality of bright spots different from each other.

However, in the case of the prior art disclosed in PTL 1, bright spots generated by the light-emitting diodes used for the eye proximity sensing and bright spots generated by the light-emitting diodes used for the line-of-sight detection cannot be distinguished, and in some cases the line-of-sight detection may not be performed at high precision. In the case of the prior art disclosed in PTL 2, the time resolution for the line-of-sight detection decreases if the plurality of light-emitting diodes emit light based on time division. Further, if the shapes of the plurality of bright spots are changed to differ from each other, the image processing to discern the bright spots becomes complicated. Moreover, in some cases, the shapes of the bright spots may be distorted by unnecessary light, which may make high precision line-of-sight detection difficult.

The present invention provides an electronic apparatus that is capable of performing the eye proximity sensing and the line-of-sight detection at high precision.

### CITATION LIST

### Patent Literature

PTL 1 Japanese Patent Laid-Open No. H07-199047
PTL 2 Japanese Patent Laid-Open No. 2016-127587

### SUMMARY OF THE INVENTION

An electronic apparatus according to the present invention is an electronic apparatus that is capable of executing eye proximity sensing to sense whether an eye is in proximity of an eyepiece, and line-of-sight detection to detect a line-of-sight of a user, including: a first light source configured to emit light for the eye proximity sensing; a second light source configured to emit light for the line-of-sight detection; an eye proximity sensing sensor configured to receive light for the eye proximity sensing; and a line-of-sight detecting sensor configured to receive light for the line-of-sight detection, wherein a first wavelength, which is a peak wavelength of the light emitted by the first light source, is different from a second wavelength, which is a peak wavelength of the light emitted by the second light source.

Further features of the present invention will become apparent from the following description of exemplary embodiments with reference to the attached drawings.

### BRIEF DESCRIPTION OF THE DRAWINGS

FIGS. 1A and 1B are external views of a camera according to the present embodiment;

FIG. 2 is a block diagram of the camera according to the present embodiment;

FIG. 3 is a cross-sectional view of the camera according to the present embodiment;

FIGS. 4A and 4B are diagrams depicting an EVF portion of the camera according to the present embodiment;

FIG. 5 is a diagram depicting optical paths of lights emitted from infrared LEDs according to the present embodiment;

FIG. 6 is a diagram depicting a principle of a line-of-sight detecting method according to the present embodiment;

FIG. 7A is a diagram depicting an eye image according to the present embodiment;

FIG. 7B is a diagram depicting a brightness distribution of the eye image according to the present embodiment;

FIG. 8 is a flow chart of the line-of-sight detecting operation according to the present embodiment;

FIG. 9 is a flow chart of the operation including the eye proximity sensing according to the present embodiment;

FIG. 10A is a graph indicating a spectral characteristic of the infrared LED according to the present embodiment; and

FIG. 10B is a graph indicating a spectral transmittance of an optical member according to the present embodiment.

### DESCRIPTION OF THE EMBODIMENTS

Preferred embodiments of the present invention will be described with reference to the accompanying drawings.

Description on Configuration

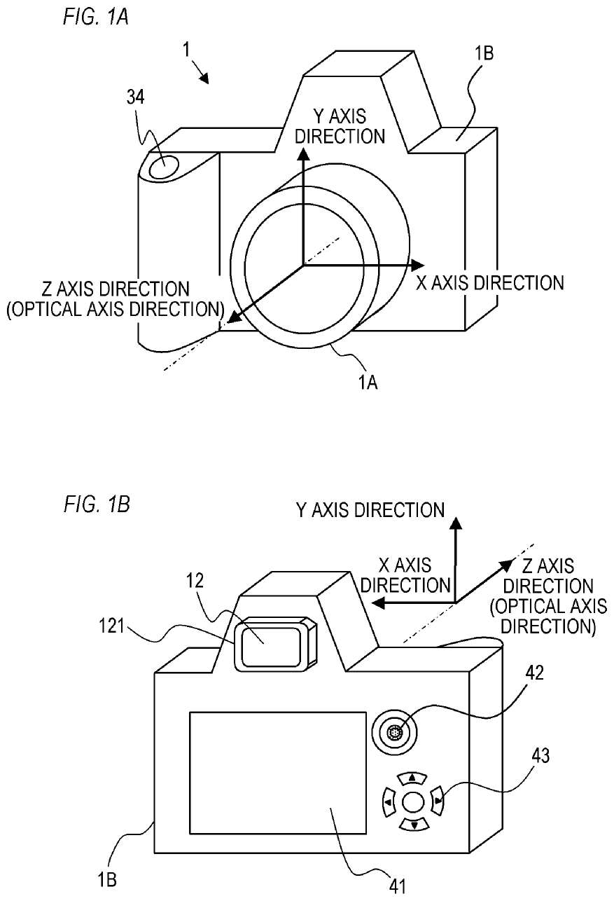

FIGS. 1A and 1B are external views of a camera 1 (digital still camera: interchangeable lens camera) according to the present embodiment. The present invention is also applicable to a device that displays such information as images and text, and to any electronic apparatus that can detect the line-of-sight of the user who visually recognizes an optical image via an ocular optical system. These electronic apparatuses may include, for example, a portable telephone, a game machine, a tablet terminal, a personal computer, a watch type or spectacle type information terminal, a head mounted display, binoculars, and the like.

FIG. 1A is a front perspective view, and FIG. 1B is a rear perspective view. As indicated in FIG. 1A, a camera 1 includes an image capturing lens unit 1A and a camera casing 1B. A release button 34, which is an operation member to receive imaging operation instructions from the user (image taker), is disposed on the camera casing 1B. As illustrated in FIG. 1B, a window frame 121, for the user to look into a later mentioned display panel 6 included in the camera casing 1B, is disposed on the rear face of the camera casing 1B. The window frame 121 forms a viewing window 12, and protrudes outward (toward the rear side) from the camera casing 1B. Operation members 41 to 43 are also disposed on the rear face of the camera casing 1B to receive various operation instructions from the user. For example, the operation member 41 is a touch panel that receives a touch operation, the operation member 42 is an operation lever which can be depressed in each direction, and the operation member 43 is a four-direction key which can be pressed in four directions respectively. The operation member 41 (touch panel) includes a display panel, such as a liquid crystal panel, and has a function to display an image on the display panel.

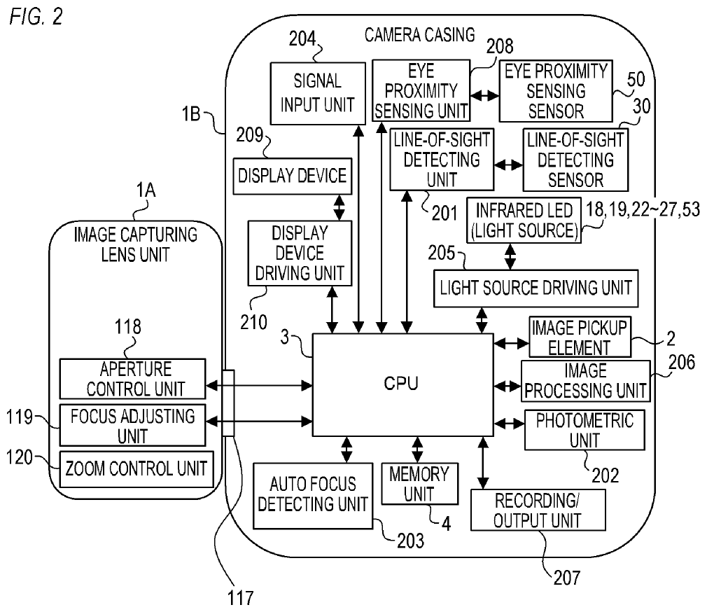

FIG. 2 is a block diagram depicting a configuration inside the camera 1.

An image pickup element 2 is such an image pickup element as a CCD and CMOS sensor, for example, and performs photoelectric conversion on an optical image, which is formed on an imaging surface of the image pickup element 2 by an optical system of the image capturing lens unit 1A, and outputs the acquired analog image signal to an A/D converting unit (not illustrated). The A/D converting unit performs A/D conversion on an analog image signal acquired by the image pickup element 2, and outputs the analog image signals as the image data.

The image capturing lens unit 1A is constituted of an optical system, which includes a zoom lens, a focus lens, an aperture, and the like. In the state of being installed in the camera casing 1B, the image capturing lens unit 1A guides the light from an object to the image pickup element 2, and forms an image of the object on the imaging plane of the image pickup element 2. An aperture control unit 118, a focus adjusting unit 119, and a zoom control unit 120 receive an instruction signal from a CPU 3 via the mount contact 117 respectively, and control the driving of the aperture, the focus lens and the zoom lens in accordance with the instruction signal respectively.

The CPU 3 included in the camera casing 1B reads a control program for each block included in the camera casing 1B from a ROM of a memory unit 4, develops the program in a RAM of the memory unit 4, and executes the program. Thereby the CPU 3 controls the operation of each block included in the camera casing 1B. A line-of-sight detecting unit 201, a photometric unit 202, an auto focus detecting unit 203, a signal input unit 204, an eye proximity sensing unit 208, a display device driving unit 210, a light source driving unit 205, and the like are connected to the CPU 3. The CPU 3 also transfers a signal, via the mount contact 117, to the aperture control unit 118, the focus adjusting unit 119 and the zoom control unit 120 disposed inside the image capturing lens unit 1A. In the present embodiment, the memory unit 4 has a function to store imaging signals from the image pickup element 2 and a line-of-sight detecting sensor 30.

The line-of-sight detecting unit 201 performs A/D conversion on the output of the line-of-sight detecting sensor 30 (an eye image of the eye) in a state where an eyeball image is formed on the line-of-sight detecting sensor 30, and sends the result of the A/D conversion to the CPU 3. The CPU 3 extracts characteristic points, which are required for the line-of-sight detection, from the eye image in accordance with the later mentioned predetermined algorithm, and calculates the line-of-sight of the user (viewpoint in the image for visual recognition) based on the positions of the characteristic points.

The eye proximity sensing unit 208 sends the output of the eye proximity sensing sensor 50 to the CPU 3. The CPU 3 calculates whether the user's eye is in proximity of the eyepiece (finder; viewing window 12 portion) in accordance with the later mentioned predetermined algorithm.

The photometric unit 202 performs amplification, logarithmic compression, A/D conversion, and the like, on signals acquired from the image pickup element 2 which plays a role of a photometric sensor (the brightness signals in accordance with the brightness of the field), and sends the result to the CPU 3 as field brightness information.

The auto focus detecting unit 203 performs A/D conversion on the signal voltage detected by a plurality of detecting elements (plurality of pixels) used for phase difference detection, which are included in the image pickup element 2 (e.g. CCD), and sends the result to the CPU 3. Based on the signals from the plurality of detecting elements, the CPU 3 computes a distance to the object, which corresponds to each focus detection point. This is a publicly known technique, which is known as imaging plane phase difference AF. In the present embodiment, it is assumed that there are focus detecting points at 180 locations on the imaging plane respectively, which are determined by dividing the visual field image (image for visual recognition) inside the finder, for example.

The light source driving unit 205 drives the later mentioned infrared LEDs 18, 19, 22 to 27 and 53 based on the signals (instructions) from the CPU 3. The infrared LEDs 18, 19 and 22 to 27 are light sources used for the line-of sight detection, and the infrared LED 53 is a light source used for the eye proximity sensing. A light source other than an infrared LED may be used instead.

The image processing unit 206 performs various image processing on the image data stored in RAM. For example, the image processing unit 206 performs various image processing to develop, display and record digital image data, such as correction processing for pixel defects caused by the optical system or image pickup element, demosaicing processing, white balance correction processing, color interpolation processing, and gamma processing.

A switch SW1 and a switch SW2 are connected to the signal input unit 204. The switch SW1 is a switch to start photometry, distance measurement, line-of-sight detecting operation, and the like, of the camera 1, and turns ON by the first stroke of the release button 34. The switch SW2 is a switch to start the image capturing operation, and turns ON by the second stroke of the release button 34. The ON signals from the switches SW1 and SW2 are inputted to the signal input unit 204, and are sent to the CPU 3. The signal input unit 204 also receives operation input from the operation member 41 (touch panel), the operation member 42 (operation lever) and the operation member 43 (four-direction key) indicated in FIG. 1B.

A recording/output unit 207 records data, include image data, in a recording medium, such as a removable memory card, or outputs the data to an external device via an external interface.

The display device driving unit 210 drives a display device 209 based on the signals from the CPU 3. The display device 209 is the later mentioned display panels 5 and 6.

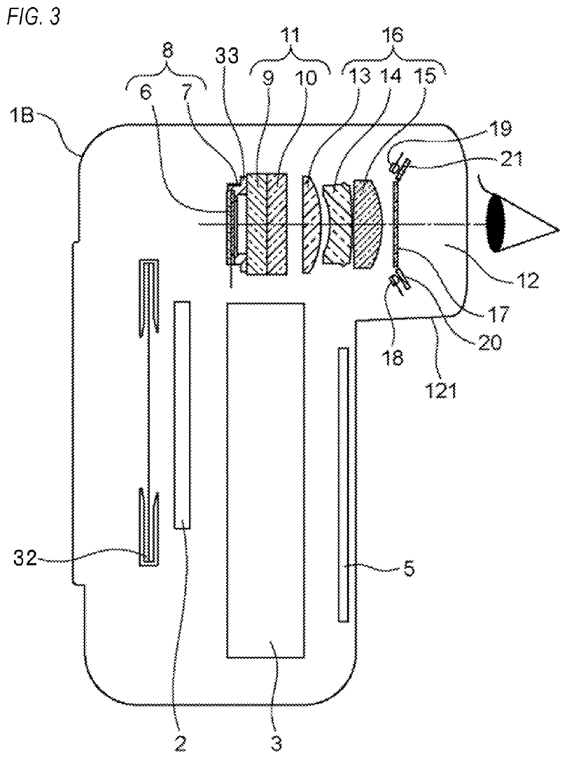

FIG. 3 is a cross-sectional view when the camera 1 is sectioned by a YZ plane formed by the Y axis and Z axis indicated in FIG. 1A, and is a conceptual diagram of the configuration of the camera 1.

A shutter 32 and the image pickup element 2 are disposed in the optical axis direction of the image capturing lens unit 1A.

The display panel 5 is disposed on the rear face of the camera casing 1B, and the display panel 5 displays a menu and images in order to operate the camera 1 and to view and edit images acquired by the camera 1. The display panel 5 is constituted of a liquid crystal panel with a backlight, an organic EL panel, or the like.

An EVF disposed in the camera casing 1B can detect the light-of-sight of the user who is looking into the EVF, reflect the detection result on the control of the camera 1, in addition to displaying the menu and images, just like the display panel 5, as a commonly used EVF.

While the user is looking into the finder, the display panel 6 displays in the same manner as the display panel 5 (displays menu and images to operate the camera 1, and view and edit images acquired by the camera 1). The display panel 6 is constituted of a liquid crystal panel with a backlight, an organic EL panel, or the like. The display panel 6 has a rectangular shape, of which size in the X direction (horizontal direction) is longer than the size in the Y direction (vertical direction), such as 3:2, 4:3 or 16:9, just like the shape of the image captured by a standard camera.

A panel holder 7 is a panel holder to hold the display panel 6. The display panel 6 and the panel holder 7 are fixed by adhesive, and constitute a display panel unit 8.

A first optical panel splitting prism 9 and a second optical path splitting prism 10 are glued together, and constitute an optical path splitting prism unit 11 (optical path splitting member). The optical path splitting prism unit 11 guides the light from the display panel 6 to an eyepiece window 17, which is disposed in a viewing window 12, and also guides a reflected light or the like from an eye (pupil) originating from the eyepiece window 17 to the line-of-sight detecting sensor 30. A dielectric multi-layered film is formed on the optical path splitting prism unit 11, and using the dielectric multi-layered film, the optical path splitting prism unit 11 suppresses the light, having the same wavelength as the peak wavelength of the light emitted from the infrared LED 53 used for eye proximity sensing, from transmitting to the side of the line-of-sight detecting sensor 30.

The display panel unit 8 and the optical path splitting prism unit 11 are fixed and integrally formed with sandwiching by a mask 33.

An ocular optical system 16 is constituted of a G1 lens 13, a G2 lens 14, and a G3 lens 15.

The eyepiece window 17 is a transparent member that transmits visible light. An image displayed on the display panel unit 8 is observed through the optical path splitting prism unit 11, the ocular optical system 16 and the eyepiece window 17.

Illumination windows 20 and 21 are windows that conceal the infrared LEDs 18, 19 and 22 to 27, so that the infrared LEDs cannot be recognized from the outside, and are constituted of resin that absorbs visible light and transmits infrared light.

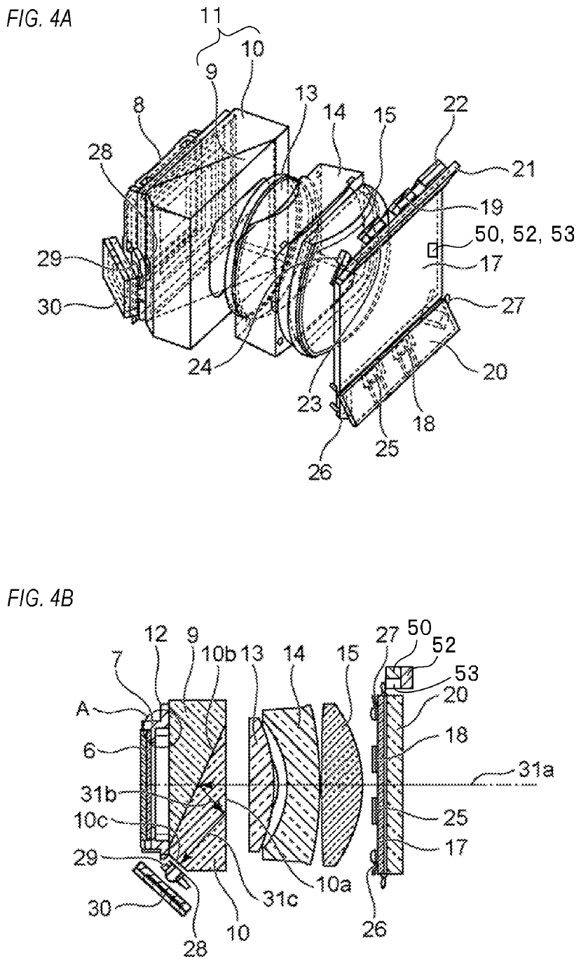

FIG. 4A is a perspective view depicting a configuration of the EVF portion of the camera 1, and FIG. 4B is a cross-sectional view of the EVF portion along the optical axis.

The infrared LEDs 18, 19, 23 and 25 are infrared LEDs for short distance illumination. The infrared LEDs 22, 24, 26 and 27 are infrared LEDs for long distance illumination. The line-of-sight detecting optical system, including an aperture 28 and a line-of-sight image forming lens 29, guides the infrared reflected light, which was guided from the eyepiece window 17 by the optical path splitting prism unit 11, to the line-of-sight detecting sensor 30. The line-of-sight detecting sensor 30 is constituted of a solid image pickup element, such as a CCD and CMOS, for example.

The eye proximity sensing sensor 50 is constituted of a photodiode or the like, which can be driven by lower power than the line-of-sight detecting sensor 30. The infrared LED 53 for the eye proximity sensing emits light to the user, and the eye proximity sensing sensor 50 receives the diffused reflected light from the user (diffused reflected light which was emitted from the infrared LED 53, and diffused and reflected by the user). An infrared absorption filter 52 is disposed in front of the eye proximity sensing sensor 50, and suppresses the light, having the same wavelength as the peak wavelength of the light emitted from the infrared LEDs 18, 19, and 22 to 27 for the line-of-sight detection, from transmitting to the side of the eye proximity sensing sensor 50.

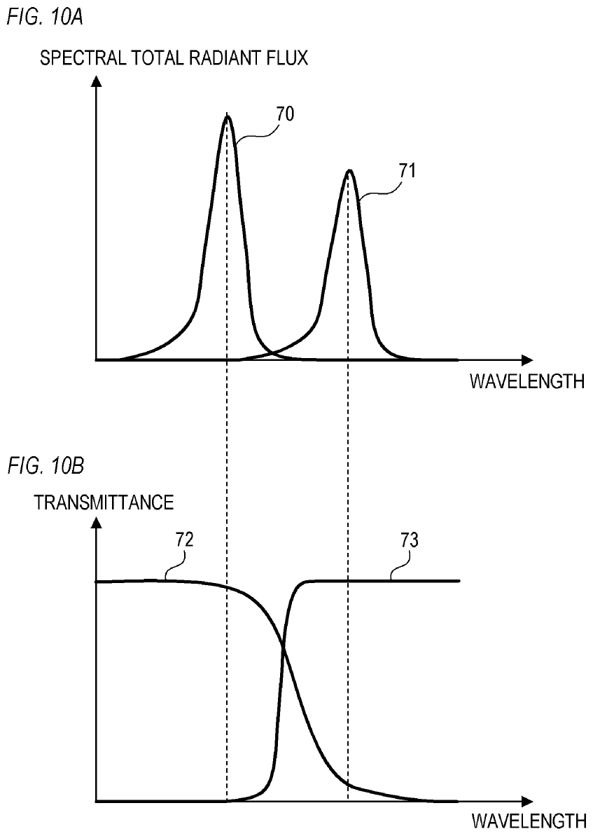

FIG. 10A is a graph indicating a spectral characteristic of the infrared LED. A light-emitting characteristic 70 is a spectral characteristic of an infrared LED 53 used for the eye proximity sensing. The light-emitting characteristic 71 is a spectral characteristic of the infrared LEDs 18, 19 and 22 to 27 used for the line-of-sight detection. As indicated in FIG. 10A, the peak wavelength of light emission is different between the infrared LEDs 18, 19 and 22 to 27 used for the line-of-sight detection and the infrared LED 53 used for the eye proximity sensing.

Further, the peak wavelength of the infrared LED 53 used for the eye proximity sensing is on the shorter wavelength side of the peak wavelength of the infrared LEDs 18, 19 and 22 to 27 used for the line-of-sight detection. In the present embodiment, it is assumed that the peak wavelength of the infrared LED 53 used for the eye proximity sensing is 850 nm, and the infrared LEDs 18, 19 and 22 to 27 used for the line-of-sight detection is 1000 nm. Furthermore, the spectral total radiant flux at the peak wavelength of the infrared LED 53 used for the eye proximity sensing is stronger than the spectral total radiant flux at the peak wavelength of the infrared LEDs 18, 19 and 22 to 27 used for the line-of-sight detection.

FIG. 10B is a graph indicating the spectral transmittance of the optical member. The transmittance characteristic 72 indicates the spectral transmittance of the infrared absorption filter 52. As indicated in FIG. 10B, the infrared absorption filter 52 suppresses the transmission of light having the peak wavelength of the infrared LEDs 18, 19 and 22 to 27 used for the line-of-sight detection. The transmittance characteristic 73 indicates the spectral transmittance of the light (spectral transmittance of the dielectric multi-layered film formed on the optical path splitting prism unit 11) when the light, which entered the optical path splitting prism unit 11 from the user side, is transmitted to the line-of-sight detecting sensor 30 side. As indicated in FIG. 10B, the optical path splitting prism unit 11 (dielectric multi-layered film) suppresses the transmission of light having the peak wavelength of the infrared LED 53 used for the eye proximity sensing.

Here a case where light is emitted from at least one of the infrared LEDs 18, 19 and 22 to 27 to the eyeball of the user who is looking into the finder will be considered. In this case, as indicated in the optical path 31a in FIG. 4B, the optical image (eyeball image) of the eyeball irradiated with the light enters the second optical path splitting prism 10 from the second surface 10a of the second optical path splitting prism 10, via the eyepiece window 17, the G3 lens 15, the G2 lens 14 and the G1 lens 13. The dielectric multi-layered film, which reflects the infrared light, is formed on the first surface 10b of the second optical path splitting prism 10, and as a reflection optical path 31b indicates, the eyeball image that entered the second optical path splitting prism 10 is reflected by the first surface 10b toward the second surface 10a side. Then, as the image forming optical path 31c indicates, the reflected eyeball image is totally reflected by the second surface 10a, and exits the second optical path splitting prism 10 through the third surface 10c of the second optical path splitting prism 10, transmits through the aperture 28, and forms an image on the line-of-sight detecting sensor 30 by the line-of-sight image forming lens 29. For the line-of-sight detection, this eyeball image, and the corneal reflex image, which is formed by the light emitted from the infrared LED that is reflected on the cornea, are used.

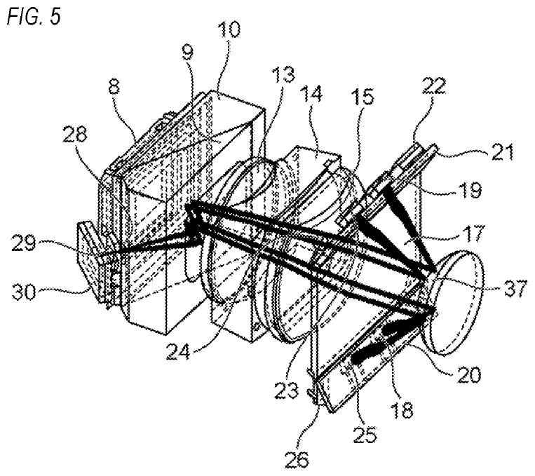

FIG. 5 is an example of the optical paths when the lights emitted from the infrared LEDs 18, 19 and 23 and 25 for short distance illumination are regularly reflected by the cornea 37 of the eyeball, and are received by the line-of-sight detecting sensor 30.

Description on Line-of-Sight Detecting Operation

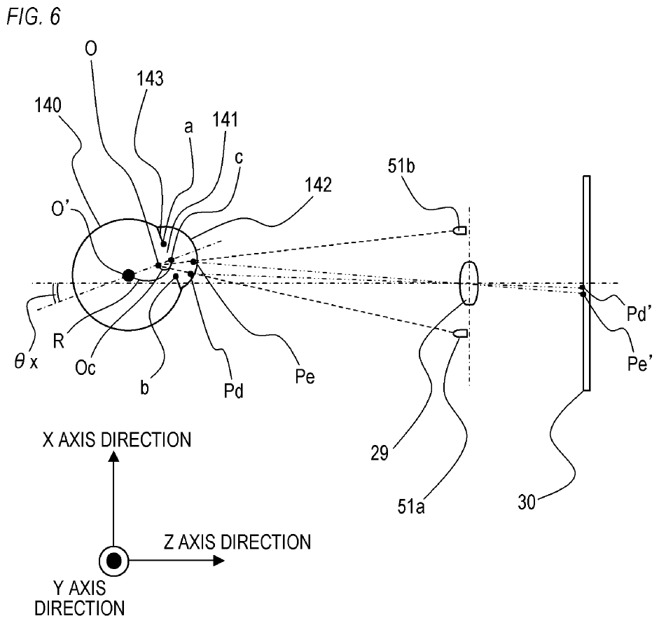

The line-of-sight detecting method will be described with reference to FIGS. 6, 7A, 7B and 8. Here an example of using two (infrared LEDs 51a and 51b in FIG. 6), out of the infrared LEDs 18, 19 and 22 to 27, will be described. FIG. 6 is a diagram for describing a principle of the line-of-sight detecting method, and is a schematic diagram of an optical system to perform the line-of-sight detection. As illustrated in FIG. 6, the infrared LEDs 51a and 51b emit infrared lights to an eyeball 140 of a user. Part of the infrared lights, which were emitted from the infrared LEDs 51a and 51b and were reflected by the eyeball 140, form an image near the line-of-sight detecting sensor 30 by the line-of-sight image forming lens 29. In FIG. 6, the positions of the infrared LEDs 51a and 51b, the line-of-sight image forming lens 29, and the line-of-sight detecting sensor 30 are adjusted such that the principle of the line-of-sight detecting method can easily be understood.

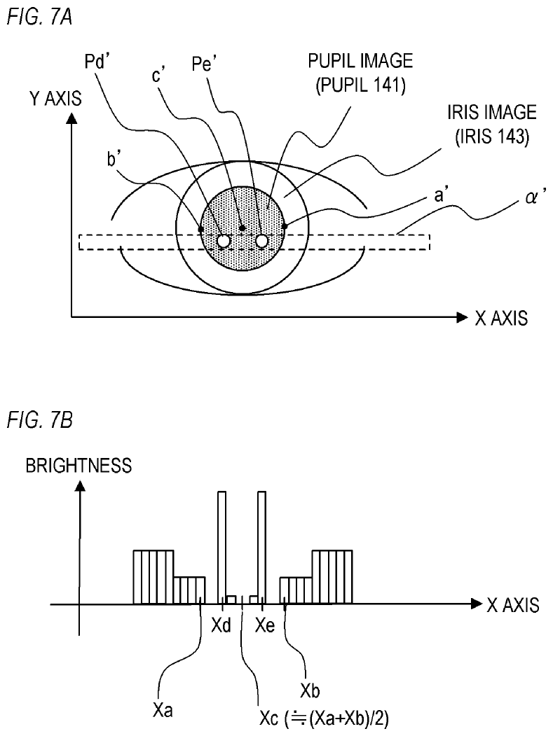

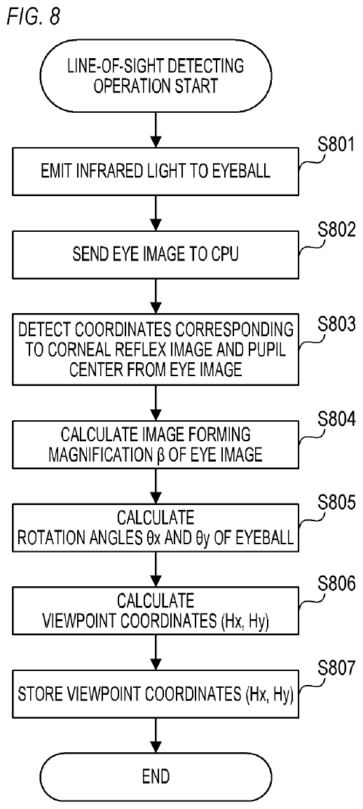

FIG. 7A is a schematic diagram of an eye image captured by the line-of-sight detecting sensor 30 (eyeball image projected to the line-of-sight detecting sensor 30), and FIG. 7B is a diagram indicating the output intensity of the line-of-sight detecting sensor 30 (e.g. CCD). FIG. 8 is a flow chart depicting an outline of the line-of-sight detecting operation.

When the line-of-sight detecting operation starts, the infrared LEDs 51a and 51b emit infrared lights toward the eyeball 140 of the user in accordance with the instruction from the light source driving unit 205 in step S801 in FIG. 8. The image of the eyeball of the user illuminated by the infrared lights is formed on the line-of-sight detecting sensor 30 via the line-of-sight image forming lens 29 (light-receiving lens), and is photo-electrically converted by the line-of-sight detecting sensor 30. Thereby a processable electric signal of the eye image can be acquired.

In step S802, the line-of-sight detecting unit 201 (line-of-sight detecting circuit) sends the eye image (eye image signal; electric signal of the eye image) acquired from the line-of-sight detecting sensor 30 to the CPU 3.

In step S803, the CPU 3 determines the coordinates of points corresponding to the corneal reflex images Pd and Pe of the infrared LEDs 51a and 51b and a point corresponding to the pupil center c from the eye image acquired in S802.

The infrared lights emitted from the infrared LEDs 51a and 51b illuminate the cornea 142 of the eyeball 140 of the user. At this time, the corneal reflex images Pd and Pe, which are formed by a part of the infrared lights reflected on the surface of the cornea 142, are collected by the line-of-sight image forming lens 29, and form images on the line-of-sight detecting sensor 30, which become the corneal reflex images Pd′ and Pe′ in the eye image. In the same manner, the lights from the edges a and b of the pupil 141 also form images on the line-of-sight detecting sensor 30, and become pupil edge images a′ and b′ in the eye image.

FIG. 7B indicates the brightness information (brightness distribution) of a region a′ in the eye image in FIG. 7A. In FIG. 7B, the horizontal direction of the eye image is the X axis direction, the vertical direction thereof is the Y axis direction, and the brightness distribution in the X axis direction is indicated. In the present embodiments, it is assumed that the coordinates of the corneal reflex images Pd′ and Pe′ in the X axis direction (horizontal direction) are Xd and Xe, and the coordinates of the pupil edge images a′ and b′ in the X axis direction are Xa and Xb. As indicated in FIG. 7B, an extremely high level of brightness is acquired at the coordinates Xd and Xe of the corneal reflex images Pd′ and Pe′. In the region from the coordinate Xa to the coordinate Xb, which corresponds to the region of the pupil 141 (region of the pupil image acquired by the light from the pupil 141 forming an image on the line-of-sight detecting sensor 30), an extremely low level of brightness is acquired except at the coordinates Xd and Xe. In the region of the iris 143 outside the pupil 141 (region of an iris image outside the pupil image, which is acquired by the light from the iris 143 forming an image), an intermediate level of brightness between the above two types of levels of brightness is acquired. Specifically, an intermediate level of brightness between the above two types of levels of brightness is acquired in a region of which X coordinate (coordinate in the X axis direction) is smaller than the coordinate Xa, and in a region of which X coordinate is larger than the coordinate Xb.

From the brightness distribution indicated in FIG. 7B, the X coordinates Xd and Xe of the corneal reflex images Pd′ and Pe′ and the X coordinates Xa and Xb of the pupil edge images a′ and b′ can be acquired. Specifically, the coordinates at which brightness is extremely high can be acquired as the coordinates of the corneal reflex images Pd′ and Pe′, and the coordinates at which brightness is extremely low can be acquired as the coordinates of the pupil edge images a′ and b′. In a case where a rotation angle θx of the optical axis of the eyeball 140, with respect to the optical axis of the line-of-sight image forming lens 29, is small, the coordinate Xc of the pupil center image c′ (center of pupil image), which is acquired by the light from the pupil center c forming on the line-of-sight detecting sensor 30, can be expressed as Xc≈(Xa+Xb)/2. In other words, the coordinate Xc of the pupil center image c′ can be calculated from the X coordinates Xa and Xb of the pupil edge images a′ and b′. In this way, the coordinates of the corneal reflex images Pd′ and Pe′ and the coordinate of the pupil center image c′ can be estimated.

In step S804, the CPU 3 calculates an image forming magnification of the eyeball image. The image forming magnification β is a magnification that is determined depending on the position of the eyeball 140 with respect to the line-of-sight image forming lens 29, and can be determined using the function of the interval (Xd-Xe) between the corneal reflex images Pd′ and Pe′.

In step S805, the CPU 3 calculates the rotation angle of the optical axis of the eyeball 140 with respect to the optical axis of the line-of-sight image forming lens 29. The X coordinate of the mid-point of the corneal reflex image Pd and the corneal reflex image Pe approximately matches with the X coordinate of the center of curvature 0 of the cornea 142. Therefore if the standard distance from the center of curvature 0 of the cornea 142 to the center c of the pupil 141 is Oc, the rotation angle θx of the eyeball 140 on the Z-X plane (plane vertical to the Y axis) can be calculated using the following Expression 1. The rotation angle θy of the eyeball 140 on the Z-Y plane (plane vertical to the X axis) can also be calculated using the same method as the calculation method for the rotation angle θx.

β×Oc×SIN θx≈{(Xd+Xe)/2}−Xc Expression 1

In step S806, the CPU 3 determines (estimates) the viewpoint of the user (position where line-of-sight is directed: position where the user is looking) in the image for visual recognition displayed on the display panel 6 using the rotation angles θx and Oy calculated in step S805. If the coordinates of the viewpoint (Hx, Hy) are coordinates corresponding to the pupil center c, then the coordinates of the viewpoint (Hx, Hy) can be calculated using the following Expressions 2 and 3.

Hx=m×(Ax×θx+Bx) Expression 2

Hy=m×(Ay×θy+By) Expression 3

The parameter m in Expressions 2 and 3 is a constant determined by the configuration of the finder optical system (line-of-sight image forming lens 29, and the like) of the camera 1, and is a conversion coefficient to convert the rotation angles θx and θy into coordinates corresponding to the pupil center c in the image for visual recognition. The parameter m is determined in advances and is stored in the memory unit 4. The parameters Ax, Bx, Ay and By are line-of-sight correction parameters to correct an individual difference of the line-of-sight, and is acquired by performing a known calibration operation, and is stored in the memory unit 4 before starting the line-of-sight detecting operation.

In step S807, the CPU 3 stores the coordinates of the viewpoint (Hx, Hy) in the memory unit 4, and ends the line-of-sight detecting operation.

Description on Operation of Camera 1, including Eye Proximity Sensing

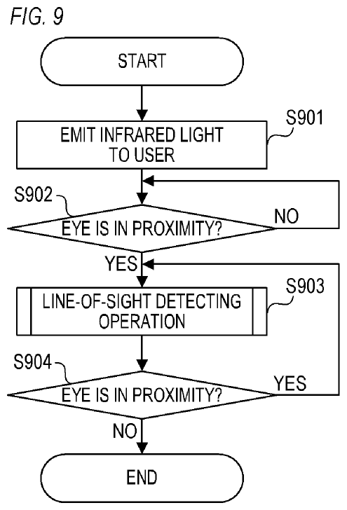

FIG. 9 is a flow chart depicting an overview of the operation of the camera 1, including the eye proximity sensing.

In step S901 in FIG. 9, the infrared LED 53 for eye proximity sensing turns ON in accordance with the instruction from the light source driving unit 205. The infrared light from the infrared LED 53 is emitted to the user, and the diffused reflected light from the user is received by the eye proximity sensing sensor 50.

In step S902, the CPU 3 determines whether the reflected light quantity received by the eye proximity sensing sensor 50, that is the received light quantity (received light intensity; received light brightness) of the eye proximity sensing sensor 50 exceeds a determination threshold Th. The determination threshold Th is stored in the memory unit 4 in advance. If the received light quantity exceeds the determination threshold Th, it is determined that the user's eye is in proximity of the eyepiece (finder: portion of viewing window 12), and processing advances to step S903. If the received light quantity does not exceed the determination threshold Th, on the other hand, it is determined that the user's eye is not in proximity of the eyepiece, and processing returns to step S902, then processing in step S902 is repeated until the received light quantity exceeds the determination threshold Th.

In step S903, the line-of-sight detecting operation described with reference to FIG. 8 is performed.

In step S904, the CPU 3 determines whether the received light quantity (received light intensity; received light brightness) of the eye proximity sensing sensor 50 exceeds the determination threshold Th. If the received light quantity exceeds the determination threshold Th, it is determined that the user's eye is in proximity of the eyepiece, and processing advances to step S903. If the received light quantity does not exceed the determination threshold Th, on the other hand, it is determined that the user turned their eye away (disengaged their eye) from the eyepiece, and the operation in FIG. 9 ends or processing returns to step S901.

As described above, according to the present embodiment, the peak wavelength of the light emission is different between the infrared LEDs 18, 19 and 22 to 27 used for the line-of-sight detection and the infrared LED 53 used for the eye proximity sensing. Thereby the lights from the infrared LEDs 18, 19 and 22 to 27 used for the line-of-sight detection and the light from the infrared LED 53 used for the eye proximity sensing can easily be distinguished from each other, and the eye proximity sensing and the line-of-sight detection can be executed at high precision. For example, if a plurality of infrared LEDs used for the line-of-sight detection are emitted based on time division, the time resolution of the line-of-sight detection drops, but in the present embodiment it is unnecessary to emit the plurality of infrared LEDs by time division, hence the time resolution of line-of-sight detection does not drop. Further, if the shapes of the plurality of bright spots caused by the plurality of infrared LEDs are different, image processing to discern each bright spots becomes complicated, but in the present embodiment, it is unnecessary to make the shapes of the plurality of bright spots different, hence the image processing does not become complicated (image processing is simple). Furthermore, the shape of a bright spot may be deformed due to the influence of unnecessary light or the like, but the above mentioned peak wavelength is not influenced by unnecessary light or the like very much.

In the present embodiment, the optical path splitting prism unit 11 is constructed such that the transmission of light having the peak wavelength of the infrared LED 53 used for the eye proximity sensing is suppressed. Thereby it can be suppressed that the line-of-sight detecting sensor 30 receives the light from the infrared LED 53 used for the eye proximity sensing, and the line-of-sight can be detected at higher precision. Here an example of constructing the optical path splitting prism unit 11 such that the transmission of the light having the peak wavelength of the infrared LED 53 is suppressed, but the present invention is not limited to this. For example, another optical member existing between the line-of-sight detecting sensor 30 and the user may be constructed such that the transmission of the light having the peak wavelength of the infrared LED 53 is suppressed. Further, a sensor of which light receiving sensitivity is low in the emission wavelength region of the infrared LED 53 may be used as the line-of-sight detecting sensor 30. In this case, improvement of the line-of-sight detecting sensor 30 (improvement to reduce light receiving sensitivity in the emission wavelength region of the infrared LED 53) is required, but an advantage is that improvement of the optical member (improvement to suppress the transmission of the light having the peak wavelength of the infrared LED 53) is unnecessary.

In the present embodiment, the dielectric multi-layered film is formed on the optical path splitting prism unit 11 in order to suppress the transmission of the light having the peak wavelength of the infrared LED 53 used for the eye proximity sensing. Compared with such an optical member as a heat absorption filter, the change in transmittance with respect to the change in wavelength is large in the case of dielectric multi-layered film. Therefore the transmission of the infrared light used for the line-of-sight detection toward the display panel 6 side can be suppressed, and a drop in light quantity used for the line-of-sight detection can be suppressed.

In the present embodiment, the infrared absorption filter 52 is constructed such that the transmission of the light having the peak wavelength of the infrared LEDs 18, 19 and 22 to 27 used for the line-of-sight detection is suppressed. Thereby the eye proximity sensing sensor 50 receiving the light from the infrared LEDs 18, 19 and 22 to 27 used for the line-of-sight detection can be suppressed, and the eye proximity sensing can be performed at higher precision. Further, if the infrared absorption filter 52 is used, the above mentioned effect can be acquired at lower cost compared with the case of using the dielectric multi-layered film or the like. Here an example of constructing the infrared absorption filter 52 such that the transmission of the light having the peak wavelength of the infrared LEDs 18, 19 and 22 to 27 is suppressed, but the present invention is not limited to this. For example, another optical member that exists between the eye proximity sensing sensor 50 and the user may be constructed such that the transmission of the light having the peak wavelength of the infrared LEDs 18, 19 and 22 to 27 is suppressed. Further, a sensor of which light receiving sensitivity is low in the emission wavelength region of the infrared LEDs 18, 19 and 22 to 27 may be used as the eye proximity sensing sensor 50. In this case, improvement of the eye proximity sensing sensor 50 (improvement to reduce light receiving sensitivity in the emission wavelength region of the infrared LEDs 18, 19 and 22 to 27) is required, but an advantage is that improvement of the optical member (improvement to suppress the transmission of the light having the peak wavelength of the infrared LEDs 18, 19 and 22 to 27) is unnecessary.

The peak wavelengths mentioned above are not especially limited, but in the present embodiment, the peak wavelength of the infrared LED 53 used for the eye proximity sensing is on the shorter wavelength side of the peak wavelength of the infrared LEDs 18, 19 and 22 to 27 used for the line-of-sight detection. Thereby the wavelength region used for the line-of-sight detection can be the wavelength region that is distant from the visible region. Of the lights which entered from the user side, the optical path splitting prism unit 11 transmits the visible light toward the display panel unit 8, and transmits the infrared light toward the line-of-sight detecting sensor 30. Generally it is difficult to construct an optical member such that the transmittance is switched from 0% to 100% at a predetermined wavelength, and the transmittance gradually changes with respect to the change in the wavelength, as indicated in FIG. 10B. By distancing the wavelength region used for the line-of-sight detection from the visible region required for the user to visually recognize the display panel 6, the light in the visible region, which is required to visually recognize the display panel 6 and is transmitted toward the line-of-sight detecting sensor 30 side, can be further suppressed. As a result, a drop in light quantity when the user views the display panel 6 side can be suppressed. Furthermore, the transmission of the infrared light used for the line-of-sight detection toward the display panel 6 side can be suppressed, and a drop in light quantity used for the line-of-sight detection can be suppressed.

The spectral total radiant flux is not especially limited, but in the present embodiment, the spectral total radiant flux at the peak wavelength of the infrared LED 53 used for the eye proximity sensing is stronger than the spectral total radiant flux at the peak wavelength of the infrared LEDs 18, 19 and 22 to 27 used for the line-of-sight detection. Thereby the eye proximity sensing can be performed at high precision, even in a state where the user is distant from the eyepiece.

The above mentioned embodiments (including modifications) are merely examples, and configurations implemented by appropriately modifying or changing the above mentioned configurations without departing from the scope of the spirit of the present invention are also included in the present invention. Configurations implemented by appropriately combining the above mentioned configurations are also included in the present invention.

According to the present disclosure, the eye proximity sensing and the line-of-sight detection can be performed at high precision.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An electronic apparatus that is capable of executing eye proximity sensing to sense whether an eye is in proximity of an eyepiece, and line-of-sight detection to detect a line-of-sight, comprising:
a first light source configured to emit light for the eye proximity sensing;
a second light source configured to emit light for the line-of-sight detection;
an eye proximity sensing sensor configured to receive light for the eye proximity sensing; and
a line-of-sight detecting sensor configured to receive light for the line-of-sight detection, wherein
a first wavelength, which is a peak wavelength of the light emitted by the first light source, is different from a second wavelength, which is a peak wavelength of the light emitted by the second light source.

2. The electronic apparatus according to claim 1, wherein
the first wavelength is a wavelength on a shorter wavelength side of the second wavelength.

3. The electronic apparatus according to claim 1, wherein
a spectral total radiant flux at the first wavelength of the light emitted by the first light source is stronger than a spectral total radiant flux at the second wavelength of the light emitted by the second light source.

4. The electronic apparatus according claim 1, further comprising
a first optical member configured to suppress transmission of light having the first wavelength, wherein
the eye proximity sensing sensor receives light transmitted through the first optical member.

5. The electronic apparatus according to claim 4, wherein
the first optical member includes an infrared absorption filter.

6. The electronic apparatus according to claim 1, further comprising
a second optical member configured to suppress transmission of light having the second wavelength, wherein
the line-of-sight detecting sensor receives light transmitted through the second optical member.

7. The electronic apparatus according to claim 6, wherein
the second optical member includes a dielectric multi-layered filter.
